(19) United States
(12) Patent Application Publication
(10) Pub. No.: US 2009/0157604 A1
(43) Pub. Date: Jun. 18, 2009

(54) Pathname translation method and system

(76) Inventor: Shailendra Tripathi, Bangalore Karnataka (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/597,674

(22) PCT Filed: Jun. 8, 2005
(86) PCT No.: PCT/US05/20147

§ 371 Date: Jan. 22, 2007

(30) Foreign Application Priority Data
Jun. 9, 2004 (GB) 0412815.3

(51) Int. Cl. G06F 17/30

(52) U.S. Cl. 707/3; 707/205; 707/E17.014; 707/E17.01

(57) ABSTRACT

A pathname translation method and system for translating a pathname that comprises one or more components (314). The system including a file system and an operation system (102); operable to perform pathname translation by searching for the components in a directory cache (308), and searching the file system for any in components not located in the directory cache (310); the directory cache contains pathname translations for substantially all of the directories in the file system.

### FIELD OF THE PRESENT INVENTION

The present invention relates generally to a pathname translation method and system, of particular but by no means exclusive application in performing pathname translation in UNIX (a trade mark of UNIX System Laboratories, Inc.) or similar operating systems.

### BACKGROUND OF THE PRESENT INVENTION

Most computer file structures have, from the user's point of view, a tree structure. This tree comprises a root directory (or, equivalently, folder) that contains individual files and/or other directories or folders; any such directories or folders will contain further files and/or other directories or folders, and so on. This root directory is named “/” in the UNIX operating system. In the following discussion, reference is made exclusively made to the UNIX operating system, but it should be understood that this is only by way of example and that the invention can be applied to other operating systems that have comparable features.

Each file in the UNIX operating system has at least one associated unique data structure called an inode, which holds the important information about that file. This information includes the file's type, its access permissions, size, the number of links to the file and the times of last access and modification. The inode also contains a list of data blocks claimed by the file, so that the file's data blocks can be accessed.

The files are thus organized as directories and accessed by means of inodes. The access of any file involves finding the inode of the file and then accessing the data blocks constituting the file according to the pointers stored in the respective inode. In existing UNIX implementations, the inode corresponding to a particular file is found by a pathname translation routine. This routine is commonly called namei( ). This technique for performing pathname translation is overhead expensive in terms of computing resources, including time, since each component in the path can result in a disk I/O operation.

One existing scheme (indeed, the approach used in existing UNIX systems) attempts to minimize the overhead cost of path translation by using a name cache (commonly called the DNLC or Directory Name Lookup Cache) that works on the principle of locality of reference. In this approach, when a user opens a file (e.g. the file “hello” with pathname “/usr/local/bin/hello”), the operating system searches for each component of the pathname in the name cache by means of namei( ). If a component is not found in the name cache, the system searches the file system on disk. Once a component is found (whether in the name cache or the file system), the next component of the pathname is searched and so on until the pathname exhausts.

Searching the file system to locate any file or directory that could not be located in the name cache, however, requires the system to perform a disk I/O operation. The details of each file or directory located by disk I/O can then be added to the name cache. However, this approach will always entail a considerable amount of disk I/O, because it is impractical to maintain a name cache of all files and directories (both owing to the number of files in a file system—which can amount to tens or hundreds of thousands—and to the frequency with which file numbers, identities and locations change). Disk I/O is more time consuming than name cache look-up by a factor of about 3×10⁵, so in this approach disk I/O will dominate the average time required to perform a pathname translation.

### SUMMARY

The invention provides a pathname translation method and system.

In particular, according to an exemplary embodiment, there is provided a pathname translation system for translating a pathname that comprises one or more (but most commonly a plurality of) components. The system includes a file system and an operating system. The operating system is operable to perform pathname translation by searching for the components in a directory cache that contains pathname translations for substantially all of the directories in the file system, and searching the file system for any components not located in the directory cache.

Thus, as there are generally considerably fewer directories than files in a file system, it is practical to provide a directory cache that contains pathname translations for substantially all of the directories in the file system.

As will be appreciated by those in the art, the term “pathname translation”, when used in respect of an individual component of a pathname, refers to the information contained in a name or directory cache that is used ultimately to locate a file or directory. In the UNIX operating system, this is the location of the file or directory's inode, which contains pointers to the data blocks constituting the file or directory.

It will be understood by the skilled person that there may be some delay in updating the directory cache, so that at some times it may not contain pathname translations for strictly all directories in the file system. Indeed, when the system is first activated, the directory cache will initially be empty but, once the system has stabilized, the directory cache will contain—as stated above—pathname translations for substantially all of the directories in the file system. The duration of initial period prior to this stable condition will depend on the way the directory cache is populated or re-populated.

Furthermore, each of the pathname translations in the directory cache relates to an individual directory, so in each case comprises a pathname translation for that directory component of the overall pathname that is being translated.

In some operating systems the term “directory” is preferred, while in others the term “folder” is preferred, even though these terms relate to the same logical file system object. Hence, the term “directory” in both this summary and in the claims refers equivalently to either a directory or a folder; the term embraces both.

It will also be understood that in this and other embodiments that the directory cache may be maintained so that changes to directory locations are reflected in the information in the directory cache.

Optionally, the system may maintain a name cache and search the name cache for each component before searching the directory cache. It will again be understood that, in this and the other embodiments that use a name cache, the name cache may be maintained so that changes to the locations of files and directories whose pathname translations are in the name cache are correctly reflected in the information in the name cache.

While a name cache is not necessary, a name cache may be used; for example, doing so means that other file systems can be mounted even if those systems do not have a directory cache. The name cache can then be relied upon exclusively for those file systems. Also, if the system is constrained in memory, the directory cache could be used for critical file systems only to reduce them amount of memory required by the directory cache. The directory cache will generally be maintained separately for each file system, unlike the name cache which will generally be maintained globally for all the file systems in a system.

This approach takes advantage of the fact that the number of directories in a file system is generally much smaller than the number of the files in the file system, and that modern computer systems are not as constrained in physical memory than such systems were in the past owing to advances in hardware technology and reductions in the cost of memory.

According to this method, it is not necessary to maintain or look up a name cache. However, it may be desirable to maintain the name cache, as the file system may be required to interact with other file systems that do not perform pathname translation according this invention (such as if they are on computer systems having particular memory constraints).

In principle, if the operating system has in some manner ascertained that a particular component refers to a file rather than a directory, the directory need not be searched and the pathname translation could employ solely the name cache (if any) and the file system. However, it may in fact be most straightforward to determine whether a component refers to a file or to a directory by searching the directory cache.

The file system may be a local hard disk, but could be or include another data storage medium or a mounted file system mounted on the local file system.

It will be understood that the data storage medium may comprise a plurality of physical data storage media, as the file may comprise a number of blocks stored on more than one physical medium.

The directory cache is preferably maintained separately from the name cache, though as will be understood that—if a name cache is used—the name cache and the directory cache could be stored in a single data file, possibly but not necessarily as distinct portions thereof.

The method may include populating the directory cache when mounting the file system. This will generally be done the first time the file system is mounted, but can be an expensive operation, so preferably the method includes saving the directory cache while unmounting the file system, and reloading the directory cache after a subsequent remounting of the file system. The directory cache would typically be saved in at least one file, and read from that file when the file system is remounted.

Thus, the next time the file system is mounted, this file can be read directly and the construction overhead cost of the directory cache will be significantly less. Further, during high memory loading on the system, this file (or pages thereof) can be swapped out of and read back into RAM (random access memory) as needed. This again incurs some overhead cost, but a significantly smaller overhead cost than were the directory cache reconstructed each time.

The method may include adding to the directory cache the directories of a subsequently mounted further file system or systems. If some or all of the further file system or systems have directory caches, the method may include accessing such directory caches; this could be to populate the main directory cache or when performing directory cache searches (in which cache the two or more directory caches act as a single directory cache for the purposes of the invention).

### BRIEF DESCRIPTION OF THE DRAWINGS

FIG. 1 is a schematic view of a computer system operable to perform pathname translation according to an exemplary embodiment;

FIG. 2 is a schematic view of the volatile memory of the computer system of FIG. 1;

FIG. 3 is a flow diagram of a pathname translation method as used in the embodiment of FIG. 1;

FIG. 4 is a flow diagram of a pathname translation method according to another embodiment; and

FIG. 5 is a schematic view of a data storage medium according to still another embodiment.

### DETAILED DESCRIPTION OF EXEMPLARY EMBODIMENTS

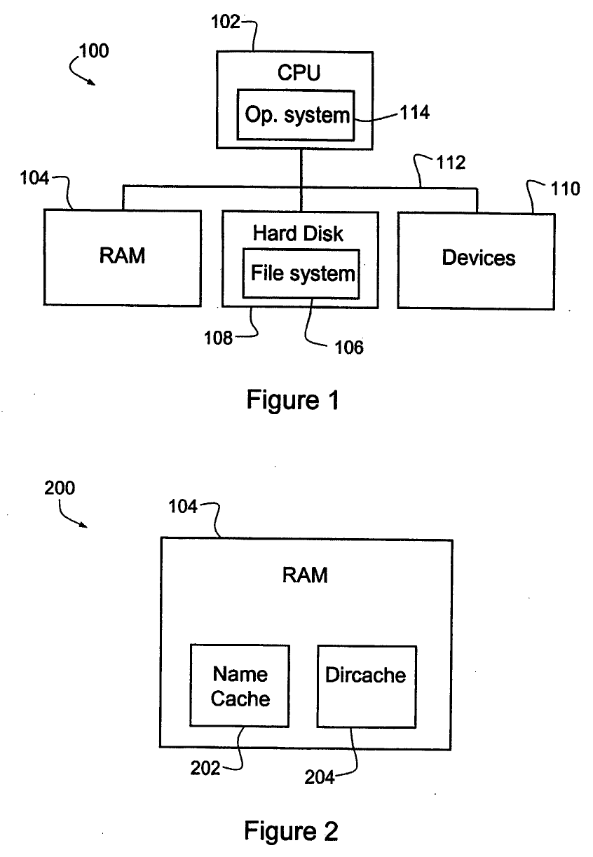

FIG. 1 is a schematic view of a computer system 100 operable to perform pathname translation according to an embodiment. The system 100 includes a processor CPU 102, volatile memory RAM 104, a file system 106 on a hard disk 108 and various input, output and other peripheral devices 110 (including keyboard, screen, etc.). The system includes a bus 112 for facilitating communications between the CPU 102, RAM 104, hard disk 108 and devices 110.

A UNIX (or equivalent) operating system is provided on the hard disk 108. In use, portions of the operating system are loaded into RAM 104 as required: these are referred to below for convenience as operating system 114.

Referring to FIG. 2, the CPU 102 includes a name cache 202 and a directory cache, dircache 204. The name cache is identical with existing name caches, so contains the pathname translations of recently accessed files and directories. The name cache 202 is maintained by the operating system 114 and is searched by the operating system 114 by means of a namei( ) routine.

The dircache 204 contains the pathname translations of every directory in the file system 106. The dircache 204 is populated with this information when the file system 106 is mounted. When the file system 106 is dismounted, the dircache 204 is saved to a file on the hard disk 108 for reloading when the file system 106 is next remounted. If at mounting the operating system 114 cannot locate an old dircache on the hard disk 108, the operating system 114 searches the file system 106 for all directories and populates the dircache 204 accordingly, but it will be appreciated that the cost (in terms of processing and other computing time) of dircache construction will be greatly reduced if an old dircache can be loaded from the hard disk 108.

Furthermore, during high memory usage, the dircache pages can if necessary be swapped out of RAM 104 and read back in as needed. This again incurs some overhead cost, but the overhead cost is expected to be significantly less than the reconstruction of the dircache 204 would entail.

The dircache 204 is stored as metadata in RAM 104. The dircache 204 is provided to reduce—as is described below—the time required to locate a file or directory by reducing the number of times hard disk 108 must be accessed. Accessing metadata in RAM is faster than accessing the disk. The dircache 204 can be regarded as any other metadata page that is buffered to speed up operations on it. It is feasible to provide sufficient physical memory to store all such directory pathname translations owing to the relatively small number of directories in a file system.

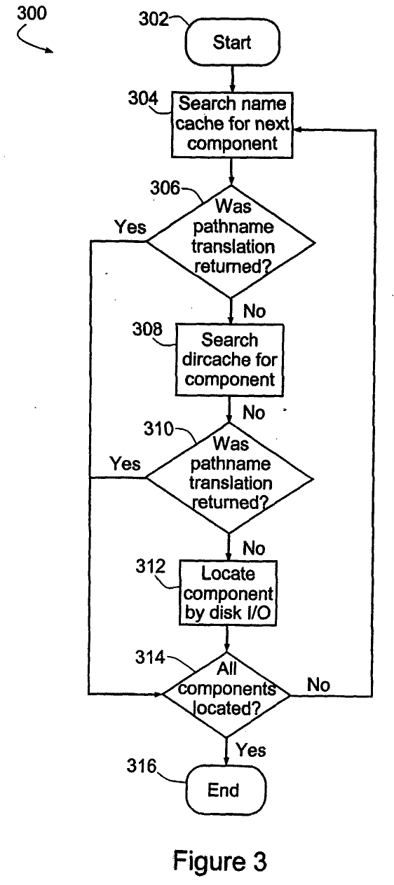

The pathname translation method according to this embodiment is performed is depicted as routine 300 in the flow diagram of FIG. 3. Referring to FIG. 3, when the operating system 114 initiates pathname translation at 302, the namei( ) routine searches 304 the name cache 202 for the next component (which on the first pass will be the first component) of the pathname. If the pathname were, for example, “/usr/local/bin/hello”, the first component would be the “/” or root directory.

The namei( ) routine returns either the pathname translation of that component or a response indicating that it failed to locate that component in the name cache. The operating system 114 determines whether the pathname translation was returned at 306. If it was, the method moves to step 314. If the pathname translation was not returned, the method proceeds to step 308, at which the dircache 204 is searched for the component. Whether the pathname translation is returned is checked at step 310. If it was returned, the routine proceeds to step 314; if not, the routine locates the component by accessing the hard disk 108 at step 312, then proceeds to step 314.

At step 314, the routine checks whether all components have been successfully located and the pathname translation completed; if so, the routine ends 316. Otherwise, the routine returns to step 304 and searches the name cache for the next component.

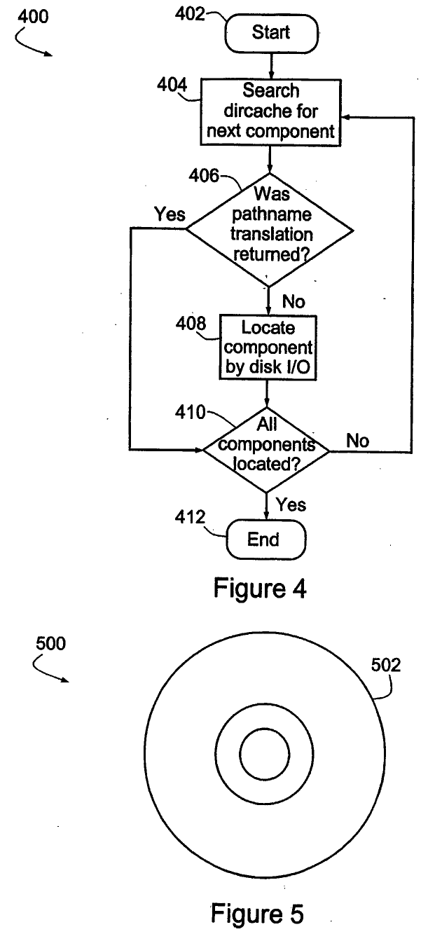

In another embodiment of a pathname translation method, a name cache is not employed. FIG. 4 is a flow diagram of the pathname translation method according to this embodiment, depicted as routine 400. Referring to FIG. 4, when the operating system 114 initiates pathname translation at 402, the namei( ) routine searches 404 the dircache 202 for the next component (which on the first pass will be the first component) of the pathname.

The namei( ) routine returns either the pathname translation of that component or a response indicating that it failed to locate that component in the dircache. The operating system 114 determines whether the pathname translation was returned at 406. If it was, the method moves to step 410. If the pathname translation was not returned, the routine locates the component by accessing the hard disk 108 at step 408, then proceeds to step 410.

At step 410, the routine checks whether all components have been successfully located and the pathname translation completed; if so, the routine ends 412. Otherwise, the routine returns to step 404 and searches the dircache for the next component.

FIG. 5 is a schematic view of a data storage medium 500 according to still another embodiment. The data storage medium 500 is in the form of a CD-ROM 502 that contains program instructions for facilitating pathname translation either in the manner described by reference to FIG. 3 or in the manner described by reference to FIG. 4. It will be understood that, in this embodiment, the particular type of data storage medium may be selected according to need or other requirements. For example, instead of CD-ROM 502 the data storage medium 500 could be in the form of a magnetic medium, but essentially any data storage medium will suffice. Indeed, the user need not be aware of which type of data storage medium is used, as the actual data storage medium could be located and accessed remotely.

The overhead cost of pathname translation according to the embodiment described by reference to FIG. 4 can readily be compared with the overhead cost arising from existing systems, by calculating the average overhead cost of path translation in a number of notional examples. In the following examples, the average overhead cost of pathname translation is determined for a path having n components (the pathname “/usr/bin/hello.c”, for example, having four components, “/”, “usr”, “bin” and “hello.c”, of which the first three are directories and the last is a file).

In the following analysis, the overhead cost of searching an entry in the name cache 202 is C, the overhead cost of accessing the hard disk 108 (i.e. disk I/O) is C′, and the overhead cost of searching for an entry in the dircache 204 is C″. In a typical system, disk I/O takes close to 3 million cycles per operation; a reasonable estimate for searching an entry in the name cache 202 is C=10 cycles. Hence, the ratio C/C is approximately 3×10⁵. The ratio of C″/C can be between 1 and 100 depending on the particular manner in which the dircache 204 is stored. The following analysis assumes the ratio of these overhead costs to be 10.

### Example 1

### Name Cache Hit Ratio: 50%

Pathname translation is generally performed for each component of the pathname separately, principally because the file system may include mounted file systems. For example, /smt on some other NFS server might be mounted on /usr/users/smt. During the translation, the system should be able to find that /smt is a mounted directory and return the appropriate result. In addition, it may and commonly will be necessary to distinguish between distinct directories or folders with the same name (cf. “hello” in /usr/local/bin/hello with “hello” in /var/bin/hello).

Thus, for each of the n components in a file's pathname (including n−1 directories), the name cache 22 is searched at an overhead cost C each time and, if that component is not found (in this example, 50% of the time), the dircache 24 is searched. The dircache contains all directories so a successful search for each of the n−1 directories is assured. Subsequently, however, the actual file must be located within the last or lowest directory, so there will also be one disk I/O operation.

Hence, the average overhead cost of a search of a path with n components, with a name cache hit ratio of 50%, is:

$$\begin{matrix}0.5 Cn + 0.5 [ Cn + {C}^{′} + ( n - 1 ) {C}^{″} ] = 0.5 Cn + 0.5 Cn + 0.5 \times 3 \times \\ {10}^{5 } C + 0.5 \times ( n - 1 ) 10 C \\ = ( n + 150000 + 5 n - 5 ) C \\ ∼ ( 6 n + 150000 ) C cycles\end{matrix}$$

Hence, the average overhead cost is approximately (6n+150000)C or (60n+1500000) cycles.

### Example 2

### Name Cache Hit Ratio: 70%

The average overhead cost of a search of a path with n components is:

$$\begin{matrix}0.7 Cn + 0.3 [ Cn + {C}^{′} + ( n - 1 ) {C}^{″} ] = 0.7 Cn + 0.3 Cn + 0.3 \times 3 \times \\ {10}^{5} C + 0.3 \times ( n - 1 ) 10 C \\ = ( n + 90000 + 3 n - 3 ) C \\ ∼ ( 4 n + 90000 ) C cycles\end{matrix}$$

Hence, the average overhead cost is approximately (4n+90000)C or (40n+900000) cycles.

### Example 3

### Name Cache Hit Ratio: 90%

The average overhead cost of a search of a path with n components:

$$\begin{matrix}0.9 Cn + 0.1 [ Cn + {C}^{′} + ( n - 1 ) {C}^{″} ] = 0.9 Cn + 0.1 Cn + 0.1 \times 3 \times {10}^{5} C + \\ 0.1 \times ( n - 1 ) 10 C \\ = ( n + 30000 + n - 1 ) C \\ ∼ ( 2 n + 30000 ) C cycles\end{matrix}$$

Hence, the average overhead cost is approximately (2n+30000)C or (20n+300000) cycles.

### Comparative Example 1

### Name Cache Hit Ratio: 50%

The prior art approach relies on disk I/O each time that the file or directory is not located in the name cache. Thus, it is necessary to replace the term (n−1)C″ in the above Examples with the term (n−1)C′ in the following Comparative Examples.

With an n component pathname, the name cache will be searched n times and, each time one attempts to locate a component in the name cache but fails, disk I/O will be required. Hence, the average overhead cost of such a search with a 50% hit ratio is:

$$\begin{matrix}0.5 Cn + 0.5 [ Cn + {C}^{′} n ] = [ 0.5 n + 0.5 n + 0.5 \times {10}^{5} n ] C \\ = ( n + 1500000 n ) C cycles\end{matrix}$$

Hence, the average overhead cost of an n path component is approximately 150000Cn or 1500000n cycles.

### Comparative Example 2

### Name Cache Hit Ratio: 70%

With an n component pathname, the average overhead cost of a search with a 70% hit ratio is:

$$\begin{matrix}0.7 Cn + 0.3 [ Cn + {C}^{′} n ] = [ 0.7 n + 0.3 n + 0.3 \times 3 \times {10}^{5} n ] C \\ = ( n + 90000 n ) C cycles\end{matrix}$$

That is, the average overhead cost of the n path component is approximately 90000Cn or 900000n cycles.

### Comparative Example 3

### Name Cache Hit Ratio: 90%

With an n component pathname, the average overhead cost of a search with a 90% hit ratio is:

$$\begin{matrix}0.9 C + 0.1 [ Cn + {C}^{′} n ] = [ 0.9 n + 0.1 n + 0.1 \times 3 \times {10}^{5} n ] C \\ ( n + 30000 n ) C cycles\end{matrix}$$

That is, the average overhead cost of the n path component is approximately 30000Cn or 300000n cycles.

The above analysis is done assuming that all the translations are requested for files. In real systems, directory translations are also performed. The number of such operations as a proportion of all operations is significant. In view of this, the constant component of the overhead cost is less than that derived above. For example, with a 10% ratio of directories to files (since there are generally considerably fewer directories than files), the overhead cost comes down as demonstrated in Examples 4 to 6.

### Example 4

### Name Cache Hit Ratio: 50%

A directory translation is very similar to a filename translation, except that the final disk I/O (cf. Examples 1 to 3) is replaced by a dircache search. Hence, where 10% of the pathname translations are directory translations, 10% of the disk I/O operations (each at an overhead cost of C′) are replaced by dircache searches (each at an overhead cost of C″). Unlike in Examples 1 to 3, the dircache will be searched for every component (including the last) of the pathname, whether the last is a directory or a file. For the last component, disk I/O is required only if the dircache search fails, that is, if it transpires that the last component is a file (90% of the time, in this Example). The average overhead cost, therefore, of pathname translation of a path with n components, and a name cache hit ratio is 50%, is:

$$\begin{matrix}0.5 Cn + 0.5 [ Cn + 0.9 {C}^{′} + {nC}^{″} ] = Cn + 0.45 \times 3 \times {10}^{5} \times C + 5 nC \\ = [ n + 1.35 \times {10}^{5} + 5 n ] C \\ = ( 6 n + 135000 ) C cycles\end{matrix}$$

Hence, the average overhead cost is (6n+135000)C or (60n+1350000) cycles.

### Example 5

### Name Cache Hit Ratio: 70%

The average overhead cost of pathname translation of a path with n components, and a name cache hit ratio is 70%, is:

$$\begin{matrix}0.7 Cn + 03 [ Cn + 0.9 {C}^{′} + {nC}^{″} ] = Cn + 0.27 \times 3 \times {10}^{5} \times C + 3 nC \\ = [ n + 0.27 \times 3 \times {10}^{5} + 3 n ] C \\ = ( 4 n + 81000 ) C cycles\end{matrix}$$

Hence, the average overhead cost is (4n+81000)C or (40n+810000) cycles.

### Example 6

### Name Cache Hit Ratio: 90%

The average overhead cost of pathname translation of a path with n components, and a name cache hit ratio is 90%, is:

$$\begin{matrix}0.9 Cn + 0.1 [ Cn + 0.9 {C}^{′} + {nC}^{″} ] = Cn + 0.09 \times 3 \times {10}^{5} \times C + nC \\ = [ n + 0.09 \times 3 \times {10}^{5} + n ] C \\ = ( 2 n + 27000 ) C cycles\end{matrix}$$

Hence, the average overhead cost is (2n+27000)C or (20n+270000) cycles.

The results from Examples 1 to 6 and the Comparative Examples are summarized in Table 1.

TABLE 1
Results of Examples 1 to 6 & Comparative Examples

| | EXAMPLES | | COMPARATIVE |
|---|---|---|---|
| Name Cache | Approx. | EXAMPLES 4 to 6 | EXAMPLES |
| Hit Ratio | Cost (cycles) | Cost (cycles) | Cost (cycles) |
| 50% | 60n + 1500000 | 60n + 1350000 | 1500000n |
| 70% | 40n + 900000 | 40n + 810000 | 900000n |
| 90% | 20n + 300000 | 20n + 270000 | 300000n |

As is apparent from these results, in Examples 1 to 6 according to this embodiment the average overhead cost of pathname translation is dominated by the overhead cost of a single disk I/O operation, and does not rise rapidly with n. In the comparative examples, the average overhead cost rises rapidly with n, as pathname translation requires a disk I/O operation for every non-hit.

According to another embodiment, the name cache is not searched. Rather, pathname translation is performed exclusively by means of a dircache and disk I/O.

Hence, Example 7 assumes—as in examples 4 to 6—that the ratio of files to directories is 90%, but does not employ a name cache.

### Example 7

With no name cache, the dircache is searched for every component; a failed search of the dircache indicates that the last pathname component is a file, and a disk I/O operation is also required. The average overhead cost of pathname translation of a path with n components and a file to directory ratio of 90%, and no name cache, is therefore:

$$\begin{matrix}[ 0.9 {C}^{′} + {nC}^{″} ] = 0.9 \times 3 \times {10}^{5} \times C + 10 nC \\ = [ 2.7 \times {10}^{5} + 10 n ] C \\ = ( 10 n + 270000 ) C cycles\end{matrix}$$

Hence, the average overhead cost is (10n+270000)C or (100n+2700000) cycles.

It is evident from the above analysis that the overhead cost of the search is considerably more constant than the prior art approach for any number of n likely to be encountered in a real file systems (in which n greater than 15 is found only infrequently).

Hence, the embodiment should yield better results in many cases. However, it is also evident that the best results are obtained in the first embodiment, in which a name cache and a dircache are both maintained and pathname translation includes searching the name cache.

The foregoing description of the exemplary embodiments is provided to enable any person skilled in the art to make or use the present invention. While the invention has been described with respect to particular illustrated embodiments, various modifications to these embodiments will readily be apparent to those skilled in the art, and the generic principles defined herein may be applied to other embodiments without departing from the spirit or scope of the invention. It is therefore desired that the present embodiments be considered in all respects as illustrative and not restrictive. Accordingly, the present invention is not intended to be limited to the embodiments described above but is to be accorded the widest scope consistent with the principles and novel features disclosed herein.

1. A pathname translation system for translating a pathname that comprises one or more components, the system comprising:
a file system; and
an operating system operable to perform pathname translation by:
searching for said components in a directory cache that contains pathname translations for substantially all of the directories in said file system; and
searching said file system for any components not located in said directory cache.

2. A system according to claim 1, wherein said operating system is further configured to search a name cache for said components before searching said directory cache, wherein said searching of said directory cache comprises a search only for components not located in said name cache.

3. A method of translating a pathname that comprises one or more components in a file system, the method comprising:
searching for said components in a directory cache that contains pathname translations for substantially all of the directories in said file system; and
searching said file system for any of said components not located in said directory cache.

4. A method according to claim 3, further comprising searching a name cache for said components before searching said directory cache for any of said components not located in said name cache.

5. A method according to claim 3, further comprising populating said directory cache when mounting said file system.

6. A method according to claim 5, further comprising populating said directory cache with the contents of an old directory cache saved when previously unmounting said file system.

7. A method according to claim 3, including saving the contents of said directory cache when unmounting said file system for reloading after a subsequent remounting of said file system.

8. A method according to claim 3, including maintaining said directory cache.

9. A method of translating a pathname that comprises one or more components in a file system, the method comprising:
searching for each of said components in a name cache;
searching for said components in a directory cache that contains pathname translations for substantially all of the directories in said file system; and
searching said file system for any components located in neither said name cache nor said directory cache.

10. A method according to claim 9, further comprising populating said directory cache when mounting said file system.

11. A method according to claim 9, further comprising populating said directory cache with the contents of an old directory cache saved when previously unmounting said file system.

12. A method according to claim 9, including maintaining said directory cache.

13. A method of facilitating pathname translation, the method comprising:
populating a directory cache with pathname translations of substantially all directories in a file system; and
maintaining said directory cache.

14. A method according to claim 13, wherein said populating of said directory cache is performed when mounting said file system.

15. A method of translating a pathname that comprises one or more components in a file system, the method comprising:
searching for any components that refer to a directory in a directory cache that contains pathname translations for substantially all of the directories in said file system; and
searching said file system for any components not located in said directory cache.

16. A method of translating a pathname that comprises one or more components in a file system, the method comprising:
searching for each of said components in a name cache;
searching for any directories not located in said name cache in a directory cache that contains pathname translations for substantially all of the directories in said file system; and
searching said file system for any components located in neither said name cache nor said directory cache.

17. A file system for a computer having a data storage device and an operating system for organizing the data into logical file system objects including files and directories, wherein said operating system is operable to perform pathname translation by:
searching a directory cache for said components, said directory cache comprising pathname translations for substantially all of the directories in said file system; and
searching said file system for any components not located in said directory cache.

18. A data storage medium containing program instructions for translating a pathname that comprises one or more components in a file system by:
searching for said components in a directory cache that contains pathname translations for substantially all of the directories in said file system; and
searching said file system for any of said components not located in said directory cache.

19. A data storage medium containing program instructions for translating a pathname that comprises one or more components in a file system by:
searching for each of said components in a name cache;
searching for said components in a directory cache that contains pathname translations for substantially all of the directories in said file system; and
searching said file system for any components located in neither said name cache nor said directory cache.

20. A data storage medium containing program instructions for facilitating pathname translation by:
populating a directory cache with pathname translations of substantially all directories in a file system; and
maintaining said directory cache.
